(19) United States
(12) Patent Application Publication
(10) Pub. No.: US 2023/0292653 A1
(43) Pub. Date: Sep. 21, 2023

(54) FERTIGATION APPARATUS

(71) Applicant: Kenneth A. McPheeters, Pasadena, CA (US)

(72) Inventor: Kenneth A. McPheeters, Pasadena, CA (US)

(21) Appl. No.: 17/892,798

(22) Filed: Aug. 22, 2022

Related U.S. Application Data
(60) Provisional application No. 63/320,736, filed on Mar. 17, 2022.

(51) Int. Cl. A01C 23/04; A01C 23/00; A01M 7/00

(52) U.S. Cl. CPC A01C 23/042; A01C 23/007; A01M 7/005

(57) ABSTRACT

A fertigation apparatus that can be installed on a water supply line of an irrigation system. The fertigation apparatus includes a body that has an open top, an inlet near the open top, and an outlet near a bottom of the body, a cap configured to close the open top, and a mesh basket encased within the body, the mesh basket can receive one or more tablets of fertilizer and pest or weed control. A diverter can selectively switch the water between the direct water supply line or through the apparatus.

### CROSS-REFERENCE TO RELATED APPLICATIONS

This application claims priority from a U.S. Provisional Pat. Appl. No. 63/320,736 filed on Mar. 17, 2022, which is incorporated herein by reference in its entirety.

### FIELD OF INVENTION

The present invention relates to a fertigation apparatus, and more particularly, the present invention relates to a fertigation apparatus that can be used in parallel to a water supply line.

### BACKGROUND

The term Fertigation refers to the application of fertilizers, pesticides, and the like with irrigation water. Fertigation has several advantages over traditional fertilization methods, such as uniform and frequent application of chemicals, precise application of nutrients, prevention of wastage of fertilizers, and runoff of the chemicals to water bodies is significantly prevented. Fertigation equipment is known in the art; however, the use of known Fertigation equipment has several drawbacks, the primary drawbacks are being complex in construction and time-consuming in use.

A need is therefore appreciated for a novel fertigation apparatus that is devoid of the drawbacks of the known fertigation equipment.

The term fertigation herein refers to application of chemicals that include fertilizers, pesticides, insecticides, and the like chemicals that are used in lawns, gardens, and the like for nutrition and protection of plants from pests and diseases. The terms “fertilizer”, “chemical” and “water-soluble products” are interchangeably used hereinafter.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a fertigation apparatus that makes the process of application of fertilizers and other water-soluble products convenient and efficient.

It is another object of the present invention that water can be saved in the application of chemicals.

It is still another object of the present invention that time can be saved.

It is a further object of the present invention that the wastage of fertilizers and other water-soluble products can be significantly prevented.

It is still a further object of the present invention that the fertilizers and other water-soluble products run-off can be significantly reduced.

It is yet a further object of the present invention that the fertilization and weed & pest control can be done simultaneously saving the water.

In one aspect, disclosed is a fertigation apparatus comprising a body that has an open top, an inlet near the open top, and an outlet near a bottom of the body; a cap configured to close the open top; and a mesh basket encased within the body, the mesh basket configured to receive one or more fertilizers or other water-soluble products tablets. The fertigation apparatus further comprises a one-way valve coupled to the inlet of the body. The fertigation apparatus further comprises a diverter coupled to the one-way valve, wherein the diverter is configured to switch water supply between an irrigation pipeline and the apparatus, wherein the irrigation pipeline directly connects the water supply to a sprinkler unit.

In one implementation, the cap is transparent/clear, and the body is translucent. The cap is sealably coupled to the body. The fertigation apparatus further comprises a wrench, the wrench configured to engage the cap for rotating and to prevent over-rotating of the cap. The fertigation apparatus further comprises an O-ring configured to be sandwiched between the cap and the body for creating a water-tight seal.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a schematic view of the disclosed fertigation apparatus, according to an exemplary embodiment of the present invention.

FIG. 2 is an exploded view of the fertigation apparatus, according to an exemplary embodiment of the present invention.

FIG. 3 is an exploded view of another embodiment of the fertigation apparatus, according to an exemplary embodiment of the present invention.

FIG. 4 is a cross-section view of the fertigation apparatus of FIG. 3, according to an exemplary embodiment of the present invention.

FIG. 5 is an exploded view of another embodiment of the fertigation apparatus, according to an exemplary embodiment of the present invention.

FIG. 6 is a perspective view of the fertigation apparatus of FIG. 5, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an” and “the” are intended to include the plural forms as well, unless the context indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagrams form in order to facilitate describing the subject innovation. Moreover, the drawings may not be to scale.

Disclosed is a fertigation apparatus for applying fertilizers, pest and/or weed control agents irrigation water. The disclosed apparatus can provide for saving water and time when applying fertilizers, pest and/or weed control agents, and provide pest and weed control to lawn, turf, garden, landscape, agricultural, and greenbelt areas. The disclosed invention can significantly save water, fertilizers, pest and/or weed control agents, and time for applying the fertilizers, pest and/or weed control agents. The disclosed fertigation apparatus can save water by eliminating multiple watering cycles while providing the necessary nutrients and weed/pest control treatment simultaneously to the lawn, turf, garden, landscape, agricultural and green-belt areas. The disclosed apparatus can be installed in an existing or new irrigation system. The fertilizers, pest and/or weed control agents in the form of tablets can be loaded into the disclosed apparatus. The disclosed apparatus can allow a user to place anyone or all three types of chemical tablets into the body of the apparatus at once. The apparatus and tablets avoid the need to measure fertilizer or pest/weed control material. The tablets provide a pre-measured quantity of fertilizers, pest and weed control products, and the tablets are water-soluble and biodegradable.

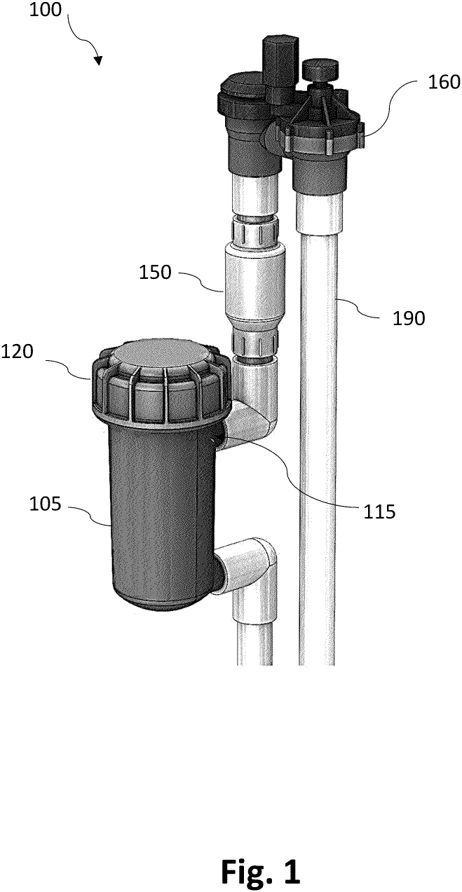

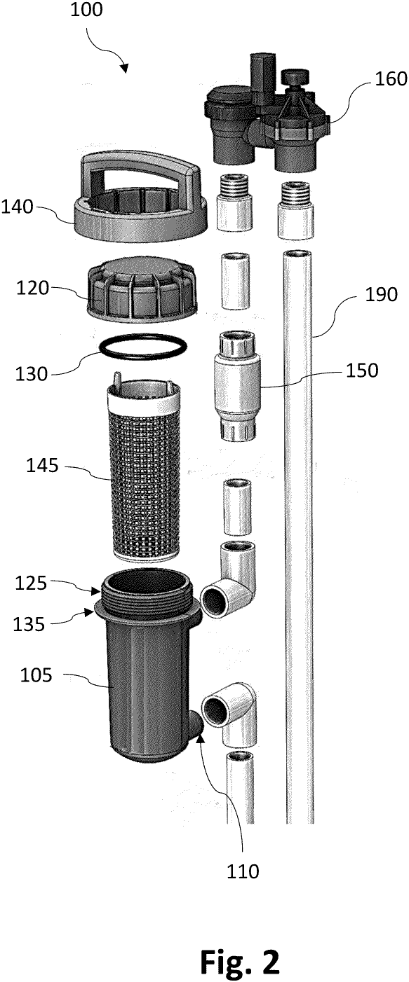

Referring to FIG. 1 which is a schematic view of the disclosed apparatus 100 shown mounted to a water supply line 190 and FIG. 2 which is an exploded view thereof. One End of the water supply line can be coupled to a water source while another end is coupled to a micro sprinkle or drip irrigation system.

The apparatus 100 includes a body 105 that is of an elongated container shape having a closed bottom, upstanding walls, and an open-top. The shape of the body can be varied from cylindrical to cuboidal without departing from the scope of the present invention.

Near the bottom can be an outlet 110 and near the top can be an inlet 115. The fertilizer tablet can be dropped into the body from the open top. The open top can be closed by a cap 120, wherein the cap and the body can have a suitable fastening mechanism for securing the cap to the body. FIG. 2 shows the upper portion of the body has a neck portion 125 that has threads on its outer surface. Similar threads can also be provided on an inner surface of a skirt of the cap so that the cap can be screwed to the threaded neck of the body. It is understood, however, that any other fastening mechanism for securing the cap to the body is within the scope of the present invention. The cap can be sealably coupled to the open top of the body to prevent any leakage under high pressure within the body. The fastening mechanism for securing the cap to the body can have a suitable seal to prevent leakage. FIG. 2 shows an O-ring 130 that can sandwich between the cap and the neck to form a watertight seal. The bottom of the neck has a circumferential flange 135 upon which the O-ring can sit. It is understood, however, that any other mechanism for making a watertight seal between the cap and the body is within the scope of the present invention. The outer surface of the cap can have suitable ridges to provide a grip for grabbing and rotating the cap for opening and closing the cap. A wrench 140 can also be provided that can interlock with ridges and/or grooves on the outer surface of the cap to rotate the cap.

The apparatus further comprises a mesh basket 145 configured to be held within the inner volume of the body. The mouth of the mesh basket can correspond to the open top of the body, such that the cap can also close the mouth of the mesh basket. The tablet fertilizer, pest or weed control product can be placed in the mesh body, and the mesh body prevents the tablets or pieces of the tablets to run into pipes and clog the same. The tablet can slowly disintegrate, and the powdered tablet can mix with water and pass through the holes in the mesh basket. The holes in the mesh basket can be such that solid granules may not pass through and block the sprinklers. The mesh basket, body, and cap can be made from a durable and water-resistant material, such as plastic, steel, aluminum, and the like. The cap can preferably be made of transparent material so that the inner volume of the body and the mesh basket is visible from the outside. The mesh basket can be removable from the body. The body can also be made from a transparent or translucent material that allows viewing the dispersion of the tablets. In particular, the cap can be made from a transparent/clear plastic material such that the dispersion of tablets can be verified from outside without the need to open the cap.

The disclosed apparatus can be installed by interrupting a water supply line of an irrigation system. The input end of the water supply line can be connected to a water source while the output end of the water supply line can be connected to a water sprinkler or drip irrigation unit. The inlet 115 of the body can be connected to the input end of the water supply line and the outlet 110 of the body can be connected to the output end of the water supply line. Now the water from the water source can pass through the inner volume of the body, and the water while passing through the body can dissolve the tablet slowly and the dissolved fertilizer in the water can pass into the water supply line reaching the sprinkler or drip irrigation unit.

The apparatus further comprises a one-way valve 150 that can be installed between the inlet of the body and the input end of the water supply line, so that any reverse flow of water can be avoided. The use of a one-way valve may ensure that the fertilizers, pest and weed control products from the tablet do not flow back to the water body, thus polluting the water body.

The apparatus may also include suitable spacers, joints, and elbows to install the disclosed apparatus.

The disclosed apparatus can be installed parallel to a water supply line so that water can pass directly from the water source to the sprinkler head. For applying the fertilizers, pest and or weed control, the line can be switched to the disclosed apparatus, wherein a diverter 160 can be provided at or near the inlet point of the water supply line and allows for switching between the direct line or bypassing a portion of the supply line through the apparatus. The diverter can further include anti-siphoning features.

In one implementation, if the water cycle is set for Wednesday for any given week, the disclosed tablet(s) can be kept in disclosed apparatus on any day on or before Wednesday, for example on Sunday. The tablets remain intact in the apparatus until water is introduced into the apparatus i.e., on Wednesday. The body and mesh basket can be custom-made to accommodate the various tablets. For example, one tablet can be about 45 or 90 grams in weight and multiple tablets of different fertilizers can be kept all at once in the mesh basket of the apparatus.

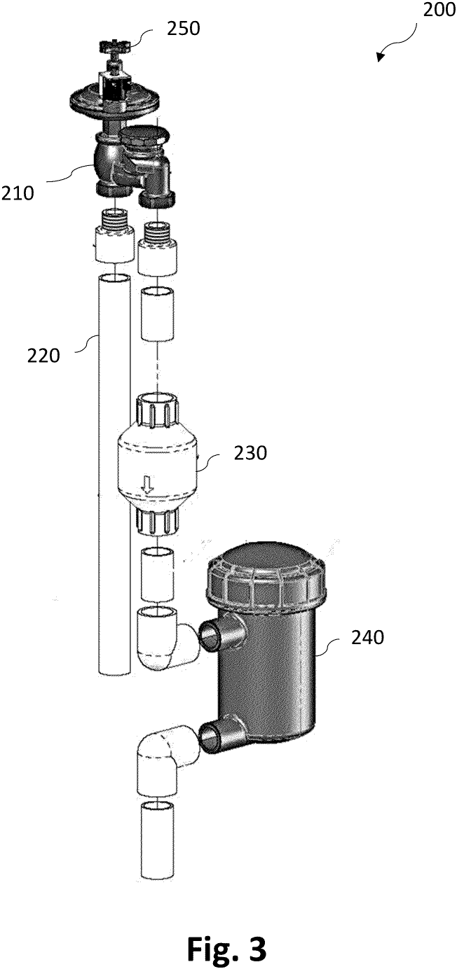

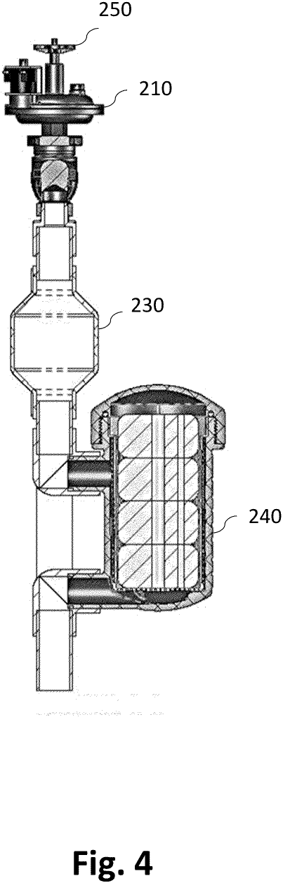

Referring to FIGS. 3 and 4, which shows another exemplary embodiment of the fertigation apparatus 200. The fertigation apparatus 200 includes a diverter 210, a water supply line 220, a one-way valve 230, and device 240 which includes the body with an inlet and outlet, a cap, and a mesh basket. The diverter 210 includes a handle 250 for turning the diverter between a first state and a second state, water in the first state goes directly through the water supply line 220 and water in the second state goes through the device 240.

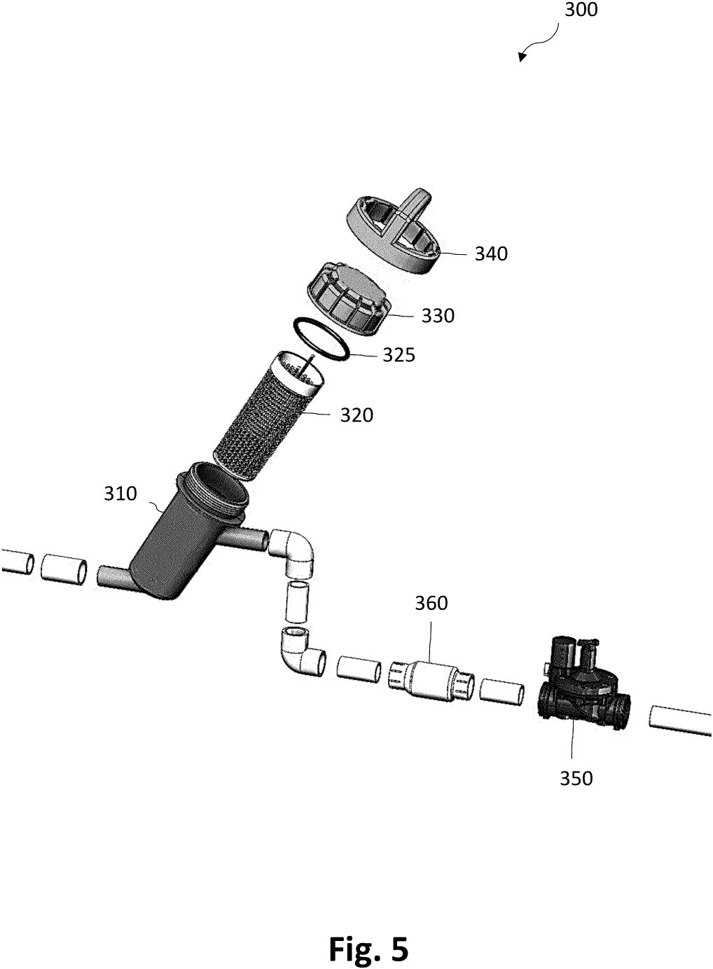

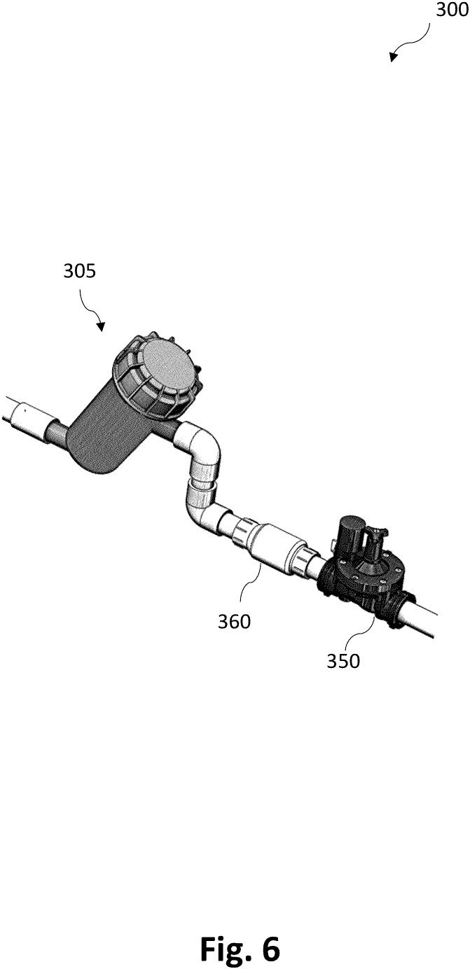

Referring to FIGS. 5 and 6 show an exemplary embodiment of the fertigation apparatus 300. The fertigation apparatus 100 includes a device 305 that includes a body 310 that has an inlet and an outlet, a mesh basket 320, an O-ring 325, a cap 330, a wrench 340, a one-way valve 360, and a diverter 360. The fertigation apparatus 300 can be suitable for underground or in-ground applications, while the fertigation apparatus 100 can be more suitable for the ground application.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A fertigation apparatus comprising:
a body that has an open top, an inlet near the open top, and an outlet near a bottom of the body;
a cap configured to close the open top; and
a mesh basket encased within the body, the mesh basket configured to receive one or more tablets of fertilizer and pest or weed control agents.

2. The fertigation apparatus according to claim 1, wherein the fertigation apparatus further comprises:
a one-way valve coupled to the inlet of the body.

3. The fertigation apparatus according to claim 2, wherein the fertigation apparatus further comprises:
a diverter coupled to the one-way valve, wherein the diverter is configured to switch water supply between a water supply line or bypassing a portion of the water supply line through the fertigation apparatus.

4. The fertigation apparatus according to claim 1, wherein the cap is transparent.

5. The fertigation apparatus according to claim 4, wherein the body is translucent.

6. The fertigation apparatus according to claim 1, wherein the cap is sealably coupled to the body.

7. The fertigation apparatus according to claim 1, wherein the fertigation apparatus further comprises a wrench, the wrench configured to engage the cap for rotating the cap.

8. The fertigation apparatus according to claim 1, wherein the fertigation apparatus further comprises an O-ring configured to be sandwiched between the cap and the body for creating a water-tight seal.

9. A method of applying chemicals to a landscape, the method comprises:
providing a fertigation apparatus comprising:
a body that has an open top, an inlet near the open top, and an outlet near a bottom of the body,
a cap configured to close the open top, and
a mesh basket encased within the body, the mesh basket configured to receive one or more tablets.

10. The method according to claim 9, wherein the fertigation apparatus further comprises:
a one-way valve coupled to the inlet of the body.

11. The method according to claim 10, wherein the fertigation apparatus further comprises:
a diverter coupled to the one-way valve, wherein the diverter is configured to switch water supply between a water supply line or bypassing a portion of the water supply line through the fertigation apparatus.

12. The method according to claim 9, wherein the cap is transparent.

13. The method according to claim 12, wherein the body is translucent.

14. The method according to claim 9, wherein the cap is sealably coupled to the body.

15. The method according to claim 9, wherein the fertigation apparatus further comprises a wrench, the wrench configured to engage the cap for rotating the cap.

16. The method according to claim 9, wherein the fertigation apparatus further comprises an O-ring configured to be sandwiched between the cap and the body for creating a water-tight seal.
